(19) United States
(12) Patent Application Publication
(10) Pub. No.: US 2008/0191507 A1
(43) Pub. Date: Aug. 14, 2008

(54) Tailgate of a Vehicle

(76) Inventor: Manfred Farber, Wielenbach (DE)

Correspondence Address: DICKINSON WRIGHT PLLC, 1901 L. STREET NW, SUITE 800, WASHINGTON, DC, 20036, US

(21) Appl. No.: 11/815,626

(22) PCT Filed: Feb. 6, 2006
(86) PCT No.: PCT/DE06/00186

§ 371 Date: Oct. 19, 2007

(30) Foreign Application Priority Data
Feb. 7, 2005 (DE) 10 2005 005 769.1

(51) Int. Cl. B62D 33/03

(52) U.S. Cl. 296/57.1

(57) ABSTRACT

The invention relates to a tailgate (9) of a vehicle, particularly a limousine or station wagon, which is moveably mounted on the vehicle by means of a bearing device for closing and opening a rear-sided loading opening (14) of the vehicle. According to the invention, the tailgate (9) is arranged on a pivoting bearing carriage (21) by means a pivoting bearing (22), said pivoting bearing carriage being displaceably mounted on a first vehicle-sided vertical guide (17) for a lifting or lowering movement. The tailgate (9) has a pivoting arm (25), whereby the control end (24) thereof is displaceably mounted on a pivoting connecting member (23) which is displaceably mounted on a second vehicle-sided vertical guide (18). The pivoting bearing carriage (21) and the pivoting connecting member (23) can be moved in a controlled manner by means of drive devices such that a simultaneous lifting or lowering movement of the pivoting bearing carriage (21) and pivoting connecting member (23) can be performed at a constant distance with a lifting or lowering movement of the tailgate (9) in the respective pivoting position thereof. It is possible to adjust the pivoting position of the tailgate (9) by means of a relative movement between the pivoting bearing carriage (21) and the pivoting connecting member (23).

The invention relates to a tailgate of a motor vehicle, particularly a sedan or station wagon or the like, which tailgate is movably mounted on the vehicle by means of a support mechanism, for closing off, and for opening for access, a rear loading opening of the vehicle.

DE 19615540 A1 discloses a station wagon having an upwardly swinging upper tailgate and a downwardly swinging lower tailgate. By swinging of one or both tailgates, the load-carrying space of the vehicle is rendered accessible from the rear. The mechanism for swinging the tailgates is not described.

DE 10225482 A1 discloses a tailgate of the general type described supra, which tailgate can be moved upwardly and downwardly as well as swung around a swing axis, by means of a raising and lowering and swinging support device disposed on vertical guides which are disposed on the rear part of the motor vehicle. When the tailgate is in the horizontal orientation, a swing arm coupled to the tailgate is lodged against a detent which is movable along the respective vertical guide.

The underlying problem of the present invention is to devise a tailgate of the type described initially supra, which has a support mechanism with improved functionality.

This problem is solved according to the invention by a tailgate having the features of claim 1. With this tailgate apparatus, the tailgate can be moved into a desired swing position through the intermediary of a swing arm guided on the “sliding carriage”, by adjustment of the variable distance between the “swinging slide” and the “sliding carriage”, which adjustment can be performed independently of the vertical positioning of the sliding carriage and of the tailgate, which vertical positioning can be achieved via the drive means. The support mechanism required for this result is comprised of simple elements and therefore is very safe and reliable in operation. In contrast to swing lever devices, the linear (or slightly curved) guide rails are simple components embodying simple structures, but are capable of sustaining high loads and forces. The tailgate may be provided with swinging means at its upper or lower edge or both, such that, when the tailgate is in a closed position, in a vertical or inclined orientation, the tailgate may be opened by swinging it upward around said upper swinging means or by swinging it downward around said lower swinging means, respectively. The inventive tailgate is particularly well suited for motor vehicles such as, e.g., sedans having a stepped rear configuration, station wagons, sport utility vehicles, or the like.

The aforesaid underlying problem is also solved by a tailgate having the features of claim 2. The slidable (or otherwise displaceable) support of the “sliding carriage” (which carriage in turn is disposed on the horizontal slide-guiding member) allows an initial opening movement of the vertically oriented closed tailgate rearward (away from the vehicle) from the sealing seat of the tailgate in the opening of the trunk (or other load-carrying space). The term “horizontal” in the context of a horizontal movement of the inventive tailgate or a horizontal movement in the horizontal slide-guiding member should be understood to mean a movement essentially in the direction of the longitudinal axis of the vehicle (the x-direction), or in a direction which is at an inclination thereto. Thus the initial “horizontal” rearward movement may also have a vertical upward or downward component.

Advantageous refinements of the invention are set forth in the dependent claims.

According to a preferred embodiment, an adjusting mechanism is provided which is in the form of an adjusting slide which is movable along a vertical guide enabling movements [relative to the horizontal slide-guiding member, and which adjusting slide is in adjusting engagement with the “sliding carriage”. The adjusting slide is adjustable independently of the other components of the support mechanism, so that the tailgate can be swung while at any vertical excursion. The adjusting slide is coupled to the “sliding carriage” by means of a linking frame [sic] which enables a relative sliding movement (or other relative displacement).

In order to being about the adjusting movement of the “sliding carriage” it may be provided that:
the adjusting slide has a curved shape in its vertical extent, which curvature provides variations with respect to the horizontal direction (the longitudinal direction of the vehicle); and/or
the vertical guide for the adjusting slide has a course with variations with respect to the horizontal direction.

An exemplary embodiment of an inventive tailgate will be described in more detail hereinbelow, with reference to the accompanying drawings.

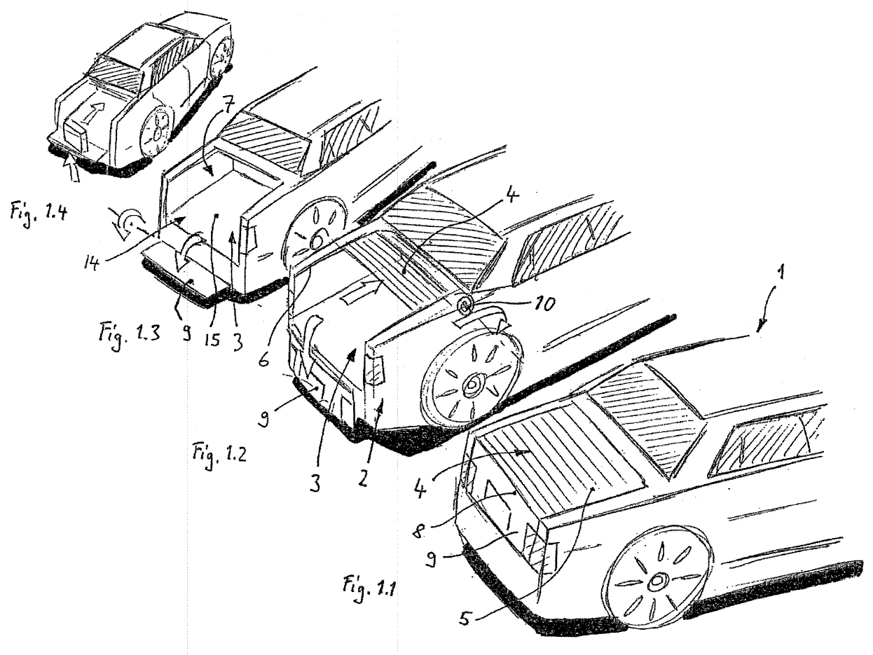

FIG. 1: FIGS. 1.1-1.4 are perspective rear views of a passenger automobile with the trunk part (British: boot part) in various opening statuses and conditions of use.

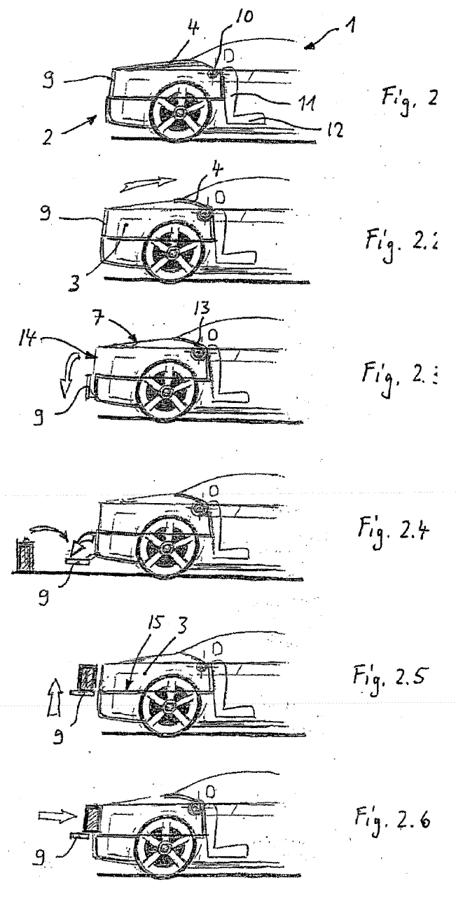

FIG. 2: FIGS. 2.1-2.6 are lateral views of the trunk part of the passenger automobile in various opening statuses and conditions of use, and with the tailgate in various positions.

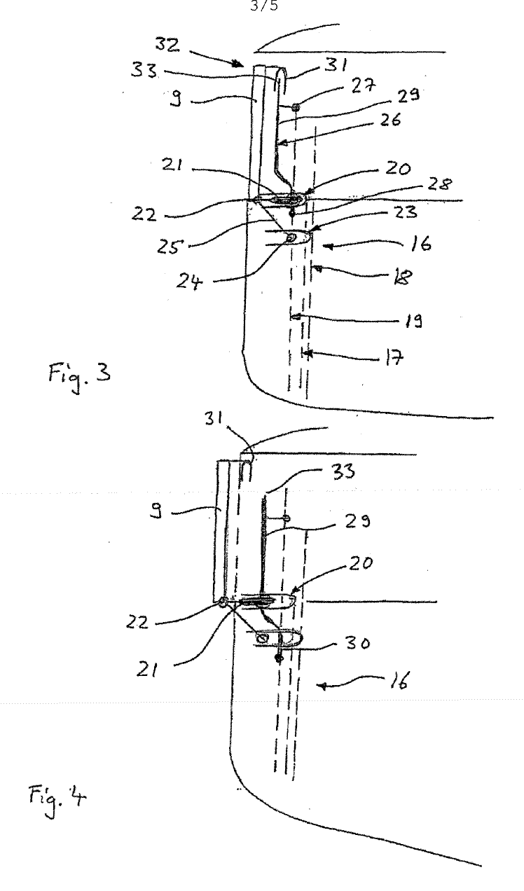

FIG. 3 is a schematic lateral view of the rear part of the automobile with the tailgate disposed in a closed position, with the aid of a support mechanism.

FIG. 4 is a schematic lateral view of the rear part of the automobile, wherein the tailgate has been released from its locked mode by the support mechanism, and has been moved rearward.

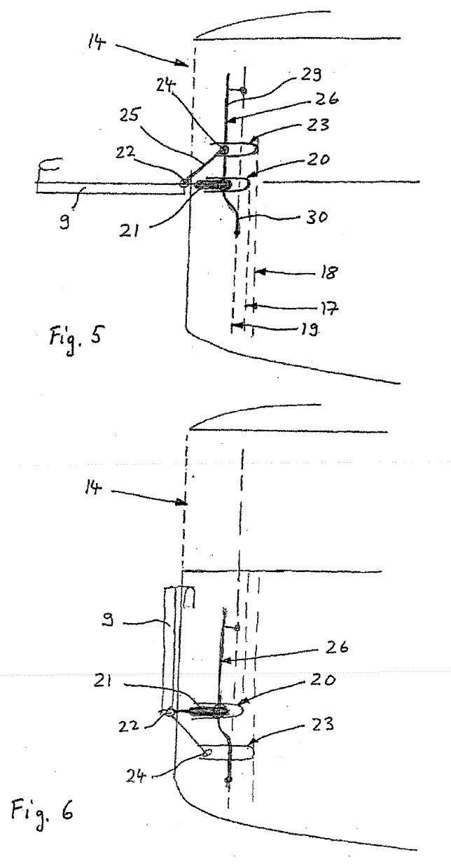

FIG. 5 is a schematic lateral view of the rear part of the automobile, wherein the tailgate has been swung out horizontally with respect to its position in FIG. 4, around a lower swing axis.

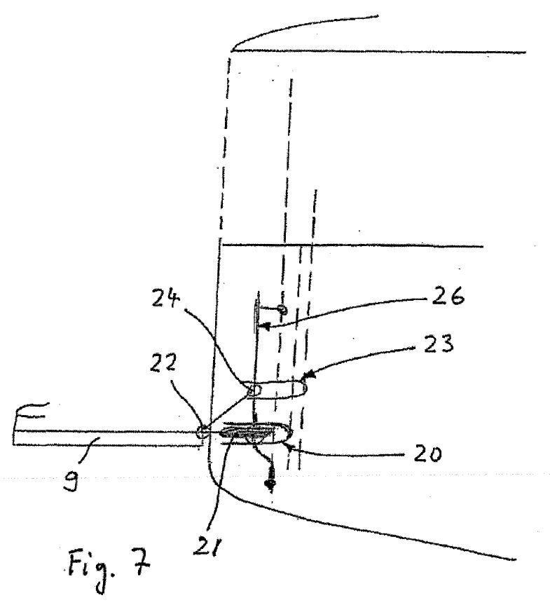

FIG. 6 [sic] is a schematic lateral view of the rear part of the automobile, wherein the tailgate has been lowered farther, below its position in FIG. 5.

FIG. 7 [sic] is a schematic lateral view of the rear part of the automobile, wherein the tailgate has been swung vertically upward around its swing axis, with respect to the tailgate position shown in FIG. 6 [sic], and into a vertical position.

A passenger automobile 1, e.g. a sedan having a stepped rear configuration (see FIGS. 1.1-1.4), has a trunk (secure carrying compartment) 3 in its rear part 2. The trunk 3 has an upper cover in the form of, e.g. a swinging trunk lid, or a “roll top” (sliding articulated panel) 4 (as illustrated in the example); the panel elements 5 of the roll top are slidably guided in two guide rails 6 disposed on the two sides of the upper opening 7 of the trunk. The roll top can be moved from a closed position in which it abuts against the upper edge 8 of a closed tailgate 9, through an intermediate position (FIG. 1.2) and forwardly into its open position (FIG. 1.3). When the roll top 4 is opened, the panel elements 5 are wound onto a shaft 10 disposed behind the back support 11 of the rear seat 12, below a cover panel or upper compartment 13.

The tailgate 9 closes off a rear trunk opening 14 which extends generally to the bottom (or close to the bottom) 15 of the trunk space 3, and in the closed position said tailgate is vertical or close to vertical. A support mechanism, which has vertical guide means 16 disposed in the lateral automobile body structures in the rear region, on both sides of the trunk space, enables the tailgate 9 to be moved and swung. FIGS. 3 to 7 illustrate schematically the tailgate 9 and the vertical guide means 16 disposed on each side. The configuration of the vertical guide means 16 is essentially the same on both sides.

Each such vertical guide means 16 is comprised of three neighboring vertical guide rails (17, 18, 19) which can be mounted on the vehicle individually or as a subassembly. The first vertical guide rail 17 bears a horizontal slide-guiding member 20 which is displaceably mounted on said rail 17 and which slide-guiding member 20 in turn bears a sliding carriage 21 which bears the swing bearing 22 for the tailgate and which sliding carriage is horizontally slidable in the x-direction (the longitudinal direction of the vehicle); in turn, the tailgate 9 is swingably mounted on the bearing 22.

The second vertical guide rail 18 bears an essentially horizontally movable [sic] swinging slide 23, by which a control element 24, which may be in the form of, e.g., a rod, is guided, which control element is associated with a swing arm 25 of the tailgate 9. The swing arm 25 is rigidly connected to the tailgate 9 in such a way that when the tailgate is closed the swing arm 25 extends at a downward and forward incline (into the vehicle) from the lower edge of the tailgate 9 to the swinging slide 23, which slide 23, in the embodiment illustrated, is disposed below the horizontal slide-guiding member 20 when the tailgate 9 is closed.

The third vertical guide rail 19 bears an adjusting slide 26 which is mounted via an upper bearing part (support part) 27 and a lower bearing par (support part) 28. The adjusting slide 26 has a curved shape in its vertical extent in the vertical longitudinal plane of the vehicle, wherewith the distance between an upper region 29 of the slide 26 and the tailgate 9 is less than the distance between a lower region 30 of slide 26 and the tailgate 9. The adjusting slide 26 slidingly engages the sliding carriage 21 (which bears the swing bearing) such that, if the slide 26 is moved vertically with respect to the sliding carriage 21, then the sliding carriage 21 is moved in the x-direction on the horizontal slide-guiding member 20, namely by a distance equal to the distance between the upper and lower regions (29, 30) of the adjusting slide 26.

A locking mechanism for the tailgate 9 is provided which is comprised of a receiving and engaging member 31 which is disposed on the tailgate 9, particularly in the region of the upper edge 32 of the tailgate 9, and a locking member 33 which is mounted or disposed on the upper region 29 of the adjusting slide 26; the locking member may be in the form of, e.g., a lug or rod extending from (or formed in) the end of the slide 26. The locking member 33 is brought into engagement with the receiving member 31 (which may be, e.g., a U-shaped member or engaging slide) by sliding the slide 26 into the locking position.

The horizontal slide-guiding member 20, the swinging slide 23, and the adjusting slide 26, are vertically movable via respective drive means (not shown). Each drive means may have a hydraulic cylinder connected to one of the said slide elements to cause vertical movement of said slide element; or may have an electric motor which drives an actuator (such as a vertical threaded spindle which engages an internally threaded element), or a lever system, or a drive cable system or the like. Suitable control means are provided to actuate and control the individual drive means for carrying out the required movements.

When the tailgate in its upper vertical closed position occludes the rear trunk space opening 14 (FIG. 3), the horizontal slide-guiding member 20 and the adjusting slide 26 are disposed at their upper positions on their respective guide rails (17; 19), and the locking member 33 on the adjusting slide 26 is lockingly engaged with the engaging member 31 on the tailgate 9. The swinging slide 23 is disposed at a defined maximum distance below the horizontal slide-guiding member 20; and accordingly the tailgate 9 is oriented in its vertical position via the swing arm 25.

To open the tailgate 9, the adjusting slide 26 is moved downward, wherewith its first movement is a defined unlocking movement which disengages the locking member 33 from the engaging member 31. During this process, the lower region 30 of the adjusting slide 26 is moved [downward] with respect to the sliding carriage 21, which carriage 21 remains in its original position (rightward position as shown in FIG. 3).

The tailgate is moved into the position according to FIG. 4 by further lowering of the adjusting slide 26 which is in sliding contact with the sliding carriage 21; as a result the carriage 21 is moved rearwardly (outwardly) in the x-direction with respect to the motor vehicle, as a result of the curved shape and the distance between the lower region 30 and upper region 29 of the adjusting slide 26, whereby the swing bearing 22 of the tailgate 9 and thereby the tailgate 9 itself is moved rearward out of the rear trunk opening 14 and away from the tight locked position of the tailgate. The vertical orientation of the tailgate 9 is unchanged, because when the sliding carriage 21 slides the tailgate 9 slides along with it, and the control element 24 in the swinging slide 23 also slides rearwardly, following the swing bearing 22 in a parallel movement path.

Starting from the position shown in FIG. 4, the tailgate 9 can be swung rearward (FIG. 5) or moved downward (FIG. 6).

In order to swing the tailgate 9 out into a horizontal position (FIG. 5), the swinging slide 23 is moved upward into a defined upper position above the horizontal slide-guiding member 20, whereby the swing arm 25 causes the tailgate 9 to be swung down around the swing bearing 22 into its horizontal position, and the control element 24 undergoes a corresponding movement [sic] in the swinging slide 23. During this process, the horizontal slide-guiding member 20 and the adjusting slide 26 are not moved. When the tailgate 9 is in its horizontal position, it can accept articles which are to be carried.

In order to move the tailgate 9 downward from the upper position according to FIG. 4 to the lower position according to FIG. 6, the horizontal slide-guiding member 20, swinging slide 23, and adjusting slide 26 are lowered synchronously, maintaining their relative positions. This causes the tailgate 9 to move downward while in its vertical orientation. This opening movement of the tailgate 9 may be carried out in particular when the vehicle is parked in such a way that the space available behind the vehicle is limited (is narrow).

In order to move the tailgate 9 downward from the upper out-swung position according to FIG. 5 to the lower out-swung position according to FIG. 7, once again the horizontal slide-guiding member 20, swinging slide 23, and adjusting slide 26 are lowered synchronously, maintaining their relative positions.

Instead of the adjusting slide 26, an adjusting mechanism may be provided on the horizontal slide-guiding member 20, to move the sliding carriage 21 which bears the swing bearing. Thus, e.g., a pinion rotatably mounted on the sliding carriage 21 and driven by an electric motor may engage a rack mounted on the horizontal slide-guiding member 20, for this purpose. With this arrangement, separate means are provided for locking the tailgate 9.

The guide rails (17; 18; 19) may be integrated in a single part or subassembly, and may have curved paths; wherewith, e.g., the tailgate 9 in the course of being raised or lowered may go through a rearwardly convex curved path which extends around a bumper of the automobile.

### LIST OF REFERENCE NUMERALS

1 passenger automobile.
2 rear part of the automobile (motor vehicle).
3 load-carrying space.
4 lid (or the like) of the load-carrying space.
5 cover (e.g. roll top cover) of the load-carrying space.
6 lower part [sic].
7 trunk opening (opening of secure carrying compartment).
9 upper edge.
10 shaft.
11 rear seat back.
12 rear seat.
13 upper compartment.
14 rear opening of trunk.
15 bottom.
16 vertical guide means.
17 guide rail.
18 guide rail.
19 guide rail.
20 horizontal slide-guiding member.
21 “sliding carriage” which bears the swing bearing.
22 swing bearing.
23 “swinging slide”.
24 control element.
25 swing arm.
26 adjusting slide.
27 upper bearing part (support part).
28 lower bearing part (support part).
29 upper region.
30 lower region.
31 receiving and engaging member.
32 upper edge.
33 locking member.

1. A tailgate of a motor vehicle, particularly a sedan or station wagon or the like, which tailgate is movably mounted on the vehicle by means of a support mechanism, for closing off, and for opening for access, a rear loading opening of the vehicle; characterized in that
the tailgate (9) is mounted on a “sliding carriage” (21) by means of a swing bearing (22), which sliding carriage (21) in turn is slidably (or otherwise displaceably) mounted on a first vertical guide (17) which is disposed generally on the vehicle side of the apparatus, for upward and downward movement; and in that
the tailgate (9) has a swing arm (25) the control end (24) of which is slidable on a “swinging slide” (23) which swinging slide (23) in turn is slidably (or otherwise displaceably) mounted on a second vertical guide (18) which is disposed generally on the vehicle side of the apparatus; and in that
the “sliding carriage” (21) and the swinging slide (23) are movable in a controlled fashion by means of drive means, such as to bring about upward or downward movement of the tailgate (9) while said tailgate is in a given swing position, by means of simultaneous upward or downward movement of the sliding carriage (21) and the swinging slide (23) while said carriage (21) and slide (23) are at a constant separation;
and in that the swing position of the tailgate (9) is adjustable by means of a relative movement between the sliding carriage (21) and the swinging slide (23).

2. A tailgate according to claim 1; characterized in that the sliding carriage (21) is movably mounted on a horizontal slide-guiding member (20) for accomplishing a horizontal movement by means of an adjusting device (26), and the horizontal slide-guiding member (20) is mounted on the first vertical guide (17) which is disposed generally on the vehicle side of the apparatus.

3. A tailgate of a motor vehicle, particularly a sedan or station wagon or the like, which tailgate is movably mounted on the vehicle by means of a support mechanism, for closing off, and for opening for access, a rear loading opening of the vehicle; characterized in that the tailgate (9) is mounted on a sliding carriage (21) by the intermediary of a swing bearing (22) which carriage (21) is movably mounted on a horizontal slide-guiding member (20), wherewith an adjusting mechanism (26) is provided for bringing about horizontal movement of said sliding carriage (21), and the horizontal slide-guiding member (20) is slidably (or otherwise displaceably) mounted on a vertical guide (17) which is disposed generally on the vehicle side of the apparatus, which guide (17) guides the raising and lowering.

4. A tailgate according to one of claims 1-3; characterized in that the adjusting mechanism (26) is comprised of an adjusting slide (26) which is movable on a vertical guide (19), in movement relative to the horizontal slide-guiding member (20), and which slide (26) engages the sliding carriage (21) in a manner such as to enable adjustment of the position of said carriage (21).

5. A tailgate according to one of claims 2-4; characterized in that, in order to accomplish the adjusting movement of the sliding carriage (21), the adjusting slide (26) has a curved shape in its vertical extent, which curvature provides variation in the horizontal direction for adjustment purposes (29, 30); and/or the vertical guide (19) for the adjusting slide (26) has a shape which varies in the horizontal direction.

6. A tailgate according to one of claims 1-5; characterized in that:
the sliding carriage (21) which bears the swing bearing, and/or the horizontal slide-guiding member (20), is/are movably mounted on a first vertical guide (17); and
the swinging slide (23) which is part of the swinging mechanism for the tailgate (9) is movably mounted on a second vertical guide (18); and
the adjusting slide (26) is movably mounted on a third vertical guide (19).

7. A tailgate according to one of claims 1-6; characterized in that locking means (31, 33) for the closed tailgate (9) are provided which are actuatable by (or from) the adjusting slide (26, 33).

8. A tailgate according to claim 7; characterized in that the locking means comprises a receiving and engaging member (31) disposed on the tailgate (9) and a locking member (33) disposed on the upper end of the adjusting slide (26).

9. A tailgate according to one of claims 1-8; characterized in that the swing bearing (22) is disposed on the lower or upper edge of the tailgate (9).
